(19) United States
(12) Patent Application Publication
(10) Pub. No.: US 2026/0175728 A1
(43) Pub. Date: Jun. 25, 2026

(54) CONTROL METHOD AND CONTROL APPARATUS

(71) Applicant: Panasonic Intellectual Property Management Co., Ltd., Osaka (JP)

(72) Inventor: MAKOTO OZONE, Osaka (JP)

(21) Appl. No.: 19/545,052

(22) Filed: Feb. 20, 2026

Related U.S. Application Data
(63) Continuation of application No. PCT/JP2024/027069, filed on Jul. 30, 2024.

(30) Foreign Application Priority Data
Sep. 8, 2023 (JP) 2023-146417

(51) Int. Cl. B60L 53/62; B60L 53/66; B60L 53/67

(52) U.S. Cl. CPC B60L 53/62; B60L 53/66; B60L 53/67

(57) ABSTRACT

A control method includes obtaining information indicating an amount of charge of at least one first electric vehicle that is connected to a power system and that is capable of receiving transmission power via a first system facility, obtaining information indicating a first threshold set for the amount of charge of the at least one first electric vehicle, and controlling, when the transmission power via the first system facility exceeds an upper limit smaller than or equal to a power capacity of the first system facility, charging or discharging of the at least one first electric vehicle on a basis of a comparison between the amount of charge of the at least one first electric vehicle and the first threshold in such a way as to reduce the transmission power via the first system facility.

### BACKGROUND

### 1. Technical Field

The present disclosure relates to a control method and a control apparatus that control charging or discharging of electric vehicles.

### 2. Description of the Related Art

Japanese Unexamined Patent Application Publication No. 2007-282383 discloses a power load leveling method for leveling power loads in a business facility. In the power load leveling method, batteries of a plurality of automobiles are charged in an off-peak period of power demand of a business facility or using night-time electricity, and power accumulated in the charged batteries of the automobiles is discharged in a peak period of the power demand.

### SUMMARY

Even when the method disclosed in Japanese Unexamined Patent Application Publication No. 2007-282383 is used, however, power demand might exceed a power capacity of a system facility. If power output from the system facility is restricted in order to avoid exceeding the power capacity, for example, a problem that it is difficult to secure an adequate amount of charge for electric vehicles connected to the system facility arises.

One non-limiting and exemplary embodiment provides a control method and the like capable of stably operating a power system and securing an adequate amount of charge for electric vehicles.

In one general aspect, the techniques disclosed here feature a control method including obtaining information indicating an amount of charge of at least one first electric vehicle that is connected to a power system and that is capable of receiving transmission power via a first system facility, obtaining information indicating a first threshold set for the amount of charge of the at least one first electric vehicle, and controlling, when the transmission power via the first system facility exceeds an upper limit smaller than or equal to a power capacity of the first system facility, charging or discharging of the at least one first electric vehicle on a basis of a comparison between the amount of charge of the at least one first electric vehicle and the first threshold in such a way as to reduce the transmission power via the first system facility.

With the control method according to the aspect of the present disclosure and the like, it is possible to stably operate a power system and secure an adequate amount of charge for electric vehicles.

It should be noted that these general or specific aspects may be implemented as a system, an apparatus, a method, an integrated circuit, a computer program, a computer-readable storage medium such as a compact disc read-only memory (CD-ROM), or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a power system according to an embodiment;

FIG. 2 is a diagram illustrating an example of a power control system according to the embodiment;

FIG. 3 is a block diagram illustrating a specific example of a power control system according to the embodiment;

FIG. 4 is a diagram illustrating information regarding power capacities of system facilities and the like;

FIG. 5 is a diagram illustrating a state of charge of an electric vehicle;

FIG. 6 is a diagram illustrating information regarding thresholds for the amount of charge set for electric vehicles and the like;

FIG. 7 is a diagram illustrating information regarding a state of charge of an electric vehicle, charging control or discharging control, and the like;

FIG. 8 is a flowchart illustrating a control method according to the embodiment;

FIG. 9 is a flowchart illustrating a control method according to a first modification of the embodiment;

FIG. 10 is a diagram illustrating states of charge of electric vehicles according to a second modification of the embodiment;

FIG. 11 is a flowchart illustrating a control method according to the second modification of the embodiment;

FIG. 12 is a flowchart illustrating a control method according to a third modification of the embodiment;

FIG. 13 is a flowchart illustrating a control method according to a fourth modification of the embodiment; and

FIG. 14 is a flowchart illustrating a control method according to a fifth modification of the embodiment.

### DETAILED DESCRIPTIONS

It is expected that, in the future, electric vehicles (EVs) will also become widely adopted as trucks and buses. These EVs are being considered for application in delivery businesses and other services as EV fleets. Charging of these EVs, however, is anticipated to increase loads on system facilities of a power system, potentially creating demand that exceeds power capacities of the system facilities. Preparing for such demand by reinforcing system facilities requires substantial investment.

To address this situation, one possible approach is to limit the amount of power supplied from the power system. However, this approach may result in insufficient power being obtained from the power system, making it difficult to secure an adequate amount of charge for EVs. It is thus not easy to achieve both stable operation of the power system and an adequate amount of charge for EVs.

The present disclosure, therefore, proposes a method and the like for controlling charging or discharging of EVs that affect a system facility in such a way as to reduce power output from the system facility when required power exceeds a power capacity of the system facility. The present disclosure also proposes a method and the like for obtaining in advance information regarding the amount of charge desired by users of EVs and controlling charging or discharging of the EVs on the basis of the amount of charge.

Control methods and control apparatuses according to aspects of the present disclosure will be described hereinafter.

A control method in example 1 includes obtaining information indicating an amount of charge of at least one first electric vehicle that is connected to a power system and that is capable of receiving transmission power via a first system facility, obtaining information indicating a first threshold set for the amount of charge of the at least one first electric vehicle, and controlling, when the transmission power via the first system facility exceeds an upper limit smaller than or equal to a power capacity of the first system facility, charging or discharging of the at least one first electric vehicle on a basis of a comparison between the amount of charge of the at least one first electric vehicle and the first threshold in such a way as to reduce the transmission power via the first system facility.

As described above, when the transmission power via the first system facility exceeds the upper limit smaller than or equal to the power capacity of the first system facility, the power system can be stably operated and charging or discharging of the at least one first electric vehicle can be appropriately controlled in accordance with the amount of charge of the at least one first electric vehicle by controlling the charging or discharging on the basis of the comparison between the amount of charge of the at least one first electric vehicle and the first threshold in such a way as to reduce the transmission power via the first system facility.

A control method in example 2 is the control method according to example 1, further including identifying an electric vehicle capable of receiving the transmission power via the first system facility.

With this configuration, for example, since an electric vehicle that affects the first system facility with respect to the transmission power is identified, charging or discharging can be controlled while determining the electric vehicle as a first electric vehicle. As a result, the power system can be stably operated, and charging or discharging can be appropriately controlled in accordance with the amount of charge of the first electric vehicle.

A control method in example 3 is the control method according to example 1 or 2, in which the first threshold is a value smaller than an amount of charge with which completion of charging of the at least one first electric vehicle is determined.

With this configuration, charging or discharging of the at least one first electric vehicle can be controlled on the basis of the comparison between the amount of charge of the at least one first electric vehicle and the first threshold, which is a value smaller than full charge of the at least one first electric vehicle. As a result, the power system can be stably operated, and charging or discharging can be appropriately controlled in accordance with the amount of charge of the at least one first electric vehicle.

A control method in example 4 is the control method according to any of examples 1 to 3, in which the first threshold is a value set by a user of the at least one first electric vehicle as an amount of charge of the at least one first electric vehicle to be secured without being discharged.

With this configuration, the power system can be stably operated, and charging or discharging can be appropriately controlled in accordance with the amount of charge of the at least one first electric vehicle that the user desires to secure.

A control method in example 5 is the control method according to any of examples 1 to 4, in which, when the transmission power via the first system facility is larger than the upper limit and the amount of charge of the at least one first electric vehicle is larger than the first threshold, power for charging the at least one first electric vehicle is reduced.

As described above, when the transmission power via the first system facility exceeds the upper limit smaller than or equal to the power capacity and the amount of charge of the at least one first electric vehicle is larger than the first threshold, the power system can be stably operated by reducing the power for charging the at least one first electric vehicle. In addition, by controlling the charging of the at least one first electric vehicle as described above, the charging can be performed while securing the amount of charge for the at least one first electric vehicle such that the amount of charge of the at least one first electric vehicle does not fall below the first threshold.

A control method in example 6 is the control method according to any of examples 1 to 5, in which, when the amount of charge of the at least one first electric vehicle is larger than the first threshold, power of the at least one first electric vehicle is discharged to the power system or a power load that is receiving power via the first system facility.

As described above, by discharging the power of the at least one first electric vehicle to the power system or the power load that is receiving power via the first system facility, the power system can be stably operated. In addition, by discharging the power of the at least one first electric vehicle when the amount of charge of the at least one first electric vehicle is larger than the first threshold, discharging can be performed while securing the amount of charge larger than or equal to the first threshold.

A control method in example 7 is the control method according to example 5 or 6, in which, when the amount of charge of the at least one first electric vehicle is smaller than the first threshold, the charging is continued.

As described above, by continuing the charging when the amount of charge of the at least one first electric vehicle is smaller than the first threshold, control can be performed such that the amount of charge of the at least one first electric vehicle becomes larger than or equal to the first threshold.

A control method in example 8 is the control method according to example 5, in which, if the transmission power via the first system facility is still larger than the upper limit even after the power for charging the at least one first electric vehicle is reduced, power of the at least one first electric vehicle is discharged to the power system or a power load that is receiving power via the first system facility.

As described above, by discharging the power of the at least one first electric vehicle to the power system or the power load that is receiving power from the first system facility, the power system can be stably operated. In addition, the at least one first electric vehicle can be discharged while securing the amount of charge larger than or equal to the first threshold.

A control method according to example 9 is the control method according to example 5, in which the at least one first electric vehicle is a plurality of first electric vehicles, and in which, if the transmission power via the first system facility is still larger than the upper limit even after power for charging a predetermined one of the plurality of first electric vehicles is reduced, power of the predetermined first electric vehicle or another first electric vehicle whose amount of charge is larger than the first threshold is discharged to the power system or a power load that is receiving power via the first system facility.

As described above, by discharging the power of the predetermined first electric vehicle or another electric vehicle to the power system or a power load that is receiving power via the first system facility, the power system can be stably operated. In addition, the at least one first electric vehicle can be discharged while securing the amount of charge larger than or equal to the first threshold.

A control method according to example 10 is the control method according to any of examples 6, 8, and 9, in which the at least one first electric vehicle is a plurality of electric vehicles, and in which, among the plurality of first electric vehicles, the at least one first electric vehicle whose amount of charge is larger relative to the first threshold is preferentially discharged.

As a described above, by preferentially discharging the at least one first electric vehicle whose amount of charge is larger relative to the first threshold, the amount of charge larger than or equal to the first threshold can be secured for the at least one first electric vehicle.

A control method according to example 11 is the control method according to any of examples 6, 8, and 9, further including obtaining information indicating an amount of charge of at least one second electric vehicle that is connected to the power system and that is capable of receiving the transmission power via the first system facility, and obtaining information indicating a first threshold set for the amount of charge of the at least one second electric vehicle, in which, if the transmission power via the first system facility exceeds the upper limit even after the power of the at least one first electric vehicle is discharged, power for charging the at least one second electric vehicle is reduced even if the amount of charge of the at least one second electric vehicle is smaller than the first threshold.

As described above, by reducing the power for charging the at least one second electric vehicle if the transmission power via the first system facility still exceeds the upper limit smaller than or equal to the power capacity even after the power of the at least one first electric vehicle is discharged, the power system can be stably operated. In addition, the amount of charge of the at least one second electric vehicle can be maintained.

A control method according to example 12 is the control method according to example 11, in which the amount of charge of the at least one second electric vehicle for which the power for charging is to be reduced is large enough to complete the charging up to the first threshold by a required charging completion time desired by a user of the at least one second electric vehicle even if the power for charging is reduced.

With this configuration, the amount of charge corresponding to the first threshold can be secured for the at least one second electric vehicle by the time desired by the user.

A control method according to example 13 is the control method according to example 11, in which the at least one second electric vehicle is a plurality of second electric vehicles, and in which power for charging, among the plurality of second electric vehicles, a second electric vehicle whose predicted charging completion time up to the first threshold has a greater margin with respect to a required charging completion time up to the first threshold desired by a user of the second electric vehicle is preferentially reduced.

With this configuration, the amount of charge corresponding to the first threshold can be secured for the at least one second electric vehicle by the time desired by the user.

A control method according to example 14 is the control method according to any of examples 11 to 13, further including obtaining information indicating a second threshold that is set for the amount of charge of the at least one second electric vehicle and that is smaller than the first threshold, in which the amount of charge of the at least one second electric vehicle for which the power for charging is to be reduced is larger than the second threshold.

With this configuration, the power for charging the at least one second electric vehicle whose amount of charge is larger than the second threshold can be reduced. As a result, the amount of charge of the at least one second electric vehicle can be secured such that the amount of charge does not fall below the second threshold.

A control method according to example 15 is the control method according to any of examples 11 to 14, in which, if the transmission power via the first system facility still exceeds the upper limit even after the power for charging the at least one second electric vehicle is reduced, power of the at least one second electric vehicle is discharged to the power system or a power load that is receiving power via the first system facility.

As described above, by discharging the power of the at least one second electric vehicle to the power system or a power load that is receiving power via the first system facility, the power system can be stably operated.

A control method according to example 16 is the control method according to any of examples 11 to 14, in which the at least one second electric vehicle is a plurality of second electric vehicles, and in which, if the transmission power via the first system facility still exceeds the upper limit even after power for charging a predetermined one of the plurality of second electric vehicles is reduced, power of the predetermined second electric vehicle or another second electric vehicle is discharged to the power system or a power load that is receiving power via the first system facility.

As described above, by discharging the power of the predetermined second electric vehicle or another second electric vehicle to the power system or a power load that is receiving power via the first system facility, the power system can be stably operated.

A control method according to example 17 is the control method according to example 16, in which, among the plurality of second electric vehicles, a second electric vehicle whose predicted charging completion time up to the first threshold has a greater margin with respect to a required charging completion time up to the first threshold desired by a user of the second electric vehicle is preferentially discharged.

With this configuration, the amount of charge corresponding to the first threshold can be secured for the at least one second electric vehicle by the time desired by the user.

A control method according to example 18 is the control method according to any of examples 15 to 17, further including obtaining information indicating the first threshold set for the amount of charge of the at least one second electric vehicle and information indicating a second threshold smaller than the first threshold, in which the amount of charge of the at least one second electric vehicle to be discharged is larger than the second threshold.

As described above, by discharging the at least one second electric vehicle whose amount of charge is larger relative to the second threshold, the amount of charge of the at least one second electric vehicle can be kept larger than the second threshold.

A control method according to example 19 is the control method according to example 15 or 16, in which the amount of charge of the at least one second electric vehicle to be discharged is large enough to complete the charging up to the first threshold by a required charging completion time desired by a user of the at least one second electric vehicle even if the at least one second electric vehicle is discharged.

With this configuration, the amount of charge corresponding to the first threshold can be secured for the at least one second electric vehicle by the time desired by the user.

A control method according to example 20 is the control method according to any of examples 1 to 4, in which the at least one first electric vehicle is a plurality of first electric vehicles, and in which, when the transmission power via the first system facility and transmission power via a second system facility different from the first system facility exceed upper limits smaller than or equal to power capacities of the corresponding system facilities, charging or discharging is controlled preferentially for, among the plurality of first electric vehicles, a first electric vehicle capable of receiving the transmission power via both the first system facility and the second system facility.

As described above, by preferentially controlling charging or discharging of the first electric vehicle capable of receiving the transmission power via both the first system facility and the second system facility, the power system including both the first system facility and the second system facility can be stably operated. In addition, the number of electric vehicles for which charging or discharging is to be controlled in order to stably operate the power system can be reduced, and an adequate amount of charge can be secured for electric vehicles.

A control method according to example 21 is the control method according to any of examples 1 to 4, in which the at least one first electric vehicle is a plurality of first electric vehicles, and in which, when the transmission power via the first system facility of the power system exceeds the upper limit smaller than or equal to the power capacity of the first system facility, charging or discharging is controlled preferentially for, among the plurality of first electric vehicles, a first electric vehicle whose power line to the first system facility is shorter.

As described above, by preferentially controlling charging or discharging of the first electric vehicle whose power line to the first system facility is shorter, responsiveness to stabilization of the power system improves, thereby reducing a possibility that the transmission power via the first system facility exceeds the power capacity of the first system facility.

A control method according to example 22 is the control method according to any of examples 1 to 4, in which the at least one first electric vehicle is a plurality of first electric vehicles, and in which, when the transmission power via the first system facility of the power system exceeds the upper limit smaller than or equal to the power capacity of the first system facility, charging or discharging is controlled preferentially for, among the plurality of first electric vehicles, a first electric vehicle that has obtained a smaller incentive in a past period.

With this configuration, incentives can be fairly given to users. As a result, the power system can be stably operated.

A control method according to example 23 includes obtaining information indicating an amount of charge of a plurality of first electric vehicles that are connected to a power system and that are capable of receiving transmission power via a first system facility, and controlling, when the transmission power via the first system facility and transmission power via a second system facility different from the first system facility exceed upper limits smaller than or equal to power capacities of the corresponding system facilities, charging or discharging preferentially for, among the plurality of first electric vehicles, a first electric vehicle capable of receiving the transmission power via both the first system facility and the second system facility in such a way as to reduce the transmission power via the first system facility.

As described above, by preferentially controlling charging or discharging of the first electric vehicle capable of receiving the transmission power via both the first system facility and the second system facility, the power system including both the first system facility and the second system facility can be stably operated. In addition, the number of electric vehicles for which charging or discharging is to be controlled in order to stably operate the power system can be reduced, and an adequate amount of charge can be secured for electric vehicles.

A control method according to example 24 include obtaining information indicating an amount of charge of a plurality of first electric vehicles that are connected to a power system and that are capable of receiving transmission power via a first system facility, and controlling, when the transmission power via the first system facility of the power system exceeds an upper limit smaller than or equal to a power capacity of the first system facility, charging or discharging preferentially for, among the plurality of first electric vehicles, a first electric vehicle whose power line to the first system facility is shorter in such a way as to reduce the transmission power via the first system facility.

As described above, by preferentially controlling charging or discharging of the first electric vehicle whose power line to the first system facility is shorter, the responsiveness to the stabilization of the power system improves, thereby reducing the possibility that the transmission power via the first system facility exceeds the power capacity of the first system facility.

A control method according to example 25 includes obtaining information indicating an amount of charge of a plurality of first electric vehicles that are connected to a power system and that are capable of receiving transmission power via the first system facility, and controlling, when the transmission power via the first system facility of the power system exceeds an upper limit smaller than or equal to a power capacity of the first system facility, charging or discharging preferentially for, among the plurality of first electric vehicles, a first electric vehicle that has obtained a smaller incentive in a past period in such a way as to reduce the transmission power via the first system facility.

With this configuration, incentives can be fairly given to users. As a result, the power system can be stably operated.

A control apparatus according to example 26 includes a first information obtainer that obtains information indicating an amount of charge of at least one first electric vehicle that is connected to a power system and that is capable of receiving transmission power via a first system facility, a second information obtainer that obtains information indicating a first threshold set for the amount of charge of the at least one first electric vehicle, and a controller that controls, when the transmission power via the first system facility exceeds an upper limit smaller than or equal to a power capacity of the first system facility, charging or discharging of the at least one first electric vehicle on a basis of a comparison between the amount of charge of the at least one first electric vehicle and the first threshold in such a way as to reduce the transmission power via the first system facility.

As described above, by controlling the charging of the at least one first electric vehicle on the basis of a comparison between the amount of charge of the at least one first electric vehicle and the first threshold in such a way as to reduce the transmission power via the first system facility when the transmission power via the first system facility exceeds the upper limit smaller than or equal to the power capacity of the first system facility, the power system can be stably operated, and charging or discharging of the at least one first electric vehicle can be appropriately controlled in accordance with the amount of charge of the at least one electric vehicle.

A control apparatus according to example 27 includes a first information obtainer that obtains information indicating an amount of charge of a plurality of first electric vehicles that are connected to a power system and that are capable of receiving transmission power via a first system facility, and a controller that controls, when the transmission power via the first system facility and transmission power via a second system facility different from the first system facility exceed upper limits smaller than or equal to power capacities of the corresponding system facilities, charging or discharging preferentially for, among the plurality of first electric vehicles, a first electric vehicle capable of receiving the transmission power via both the first system facility and the second system facility in such a way as to reduce the transmission power via the first system facility.

As described above, by preferentially controlling charging or discharging of the first electric vehicle capable of receiving the transmission power via both the first system facility and the second system facility, the power system including both the first system facility and the second system facility can be stably operated. In addition, the number of electric vehicles for which charging or discharging is to be controlled in order to stably operate the power system can be reduced, and an adequate amount of charge can be secured for electric vehicles.

A control apparatus according to example 28 includes a first information obtainer that obtains information indicating an amount of charge of a plurality of first electric vehicles that are connected to a power system and that are capable of receiving transmission power via a first system facility, and a controller that controls, when the transmission power via the first system facility of the power system exceeds an upper limit smaller than or equal to a power capacity of the first system facility, charging or discharging preferentially for, among the plurality of first electric vehicles, a first electric vehicle whose power line to the first system facility is shorter in such a way as to reduce the transmission power via the first system facility.

As described above, by preferentially controlling charging or discharging of the first electric vehicle whose power line to the first system facility is shorter, the responsiveness to the stabilization of the power system improves, thereby reducing the possibility that the transmission power via the first system facility exceeds the power capacity of the first system facility.

A control apparatus according to example 29 includes a first information obtainer that obtains information indicating an amount of charge of a plurality of first electric vehicles that are connected to a power system and that are capable of receiving transmission power via the first system facility, and a controller that controls, when the transmission power via the first system facility of the power system exceeds an upper limit smaller than or equal to a power capacity of the first system facility, charging or discharging preferentially for, among the plurality of first electric vehicles, a first electric vehicle that has obtained a smaller incentive in a past period in such a way as to reduce the transmission power via the first system facility.

With this configuration, incentives can be fairly given to users. As a result, the power system can be stably operated.

Furthermore, these general or specific aspects may be implemented as a system, an apparatus, a method, an integrated circuit, a computer program, a non-transitory storage medium such as a CD-ROM, or any selective combination thereof.

An embodiment will be described hereinafter with reference to the drawings. The embodiment described hereinafter is a general or specific example. Values, shapes, materials, components, arrangement positions and connection modes of the components, steps, order of the steps, and the like are examples, and not intended to limit the claims.

### EMBODIMENT

### Configuration of Control Apparatus and Other Equipment

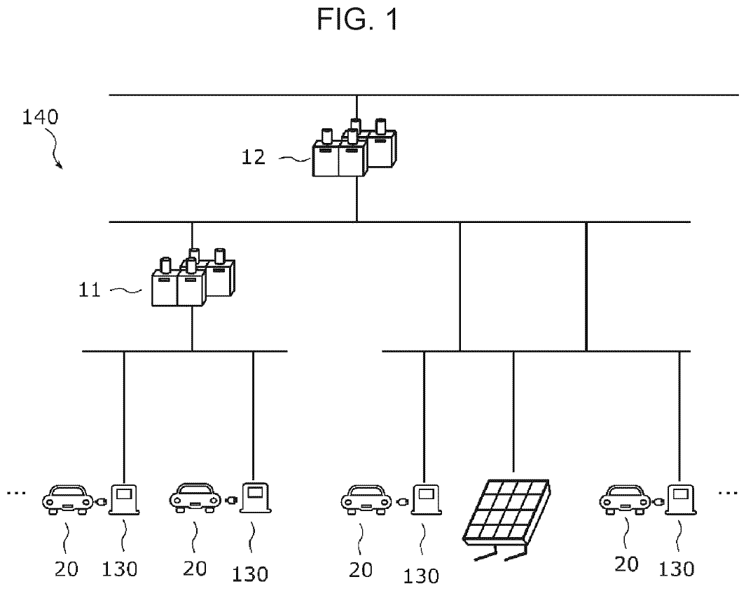

Configuration of a control apparatus and other equipment according to an embodiment will be described with reference to FIGS. 1 to 7.

FIG. 1 is a diagram illustrating an example of a power system 140 according to the embodiment.

The power system 140 illustrated in FIG. 1 is, for example, a commercial power supply and performs roles of power generation, transformation, transmission, distribution, and the like. System facilities of the power system 140 include substation facilities and a distribution network and has power capacities. FIG. 1 illustrates a first substation facility, which is an example of a first system facility, and a second substation facility, which is an example of a second system facility. In the following description, the first system facility will be referred to as a system facility 11, and the second system facility will be referred to as a system facility 12.

The system facility 11 and the system facility 12 are provided, for example, at branching points of the distribution network or the like. The system facility 11 in FIG. 1 is provided at a lower level than the system facility 12. The system facility 11 may be provided at the same level as the system facility 12, instead.

FIG. 1 illustrates a plurality of charging sites 130. Here, a “site” can also refer to a facility at the site. The plurality of charging sites 130 is connected to the system facility 11 via distribution lines. When the plurality of charging sites 130 receives power from the system facility 11, the plurality of charging sites 130 shares the system facility 11. EVs 20 are connected to the charging sites 130.

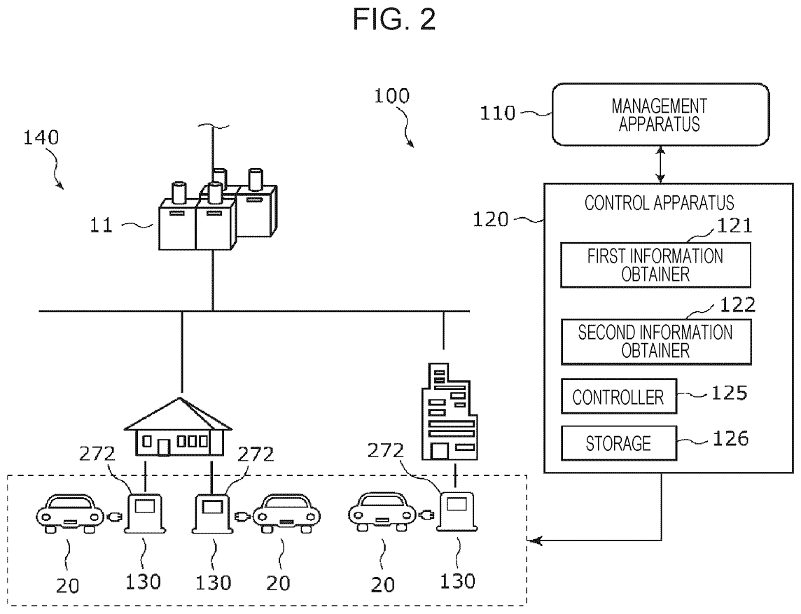

FIG. 2 is a diagram illustrating an example of a power control system 100 according to the embodiment.

The power control system 100 illustrated in FIG. 2 is a system that controls charging or discharging of the EVs 20. The power control system 100 includes a management apparatus 110, a control apparatus 120, the power system 140, and the plurality of charging sites 130.

The EVs 20 are connected to the power system 140 via the charging sites 130 and can receive transmission power output from the power system 140.

The charging sites 130 are charging facilities (e.g., charging stations) that charge or discharge batteries of the EVs 20. Each charging site 130 includes one or a plurality of chargers 272. The charging sites 130 charge or discharge the EVs 20 on the basis of control commands from the management apparatus 110 or the control apparatus 120.

The management apparatus 110 is a computer, for example, and performs a role of managing the components of the power control system 100. The management apparatus 110 manages transmission power of the power system 140. More specifically, the management apparatus 110 manages transmission power flowing through the power system 140 and the system facility 11 (or 12) in the power system 140 on the basis of power demands of the plurality of charging sites 130 and the like. The management apparatus 110 is provided at a higher level than the control apparatus 120.

The control apparatus 120 is provided at a lower level than the management apparatus 110. The control apparatus 120 is a computer, for example, and performs a role of managing the charging sites 130 and the like included in the power control system 100.

The control apparatus 120 holds information regarding a power capacity of the system facility 11 (or 12). For example, the control apparatus 120 obtains information regarding the power capacity of the system facility 11 (or 12) from the management apparatus 110, which manages the transmission power of the power system 140.

Although an example in which the management apparatus 110 and the control apparatus 120 are separate components has been described, the management apparatus 110 and the control apparatus 120 may be integrated with each other, instead. For example, the management apparatus 110 may include the control apparatus 120 and perform the role of the control apparatus 120.

As illustrated in FIG. 2, the control apparatus 120 includes a controller 125 and a storage 126. The control apparatus 120 also includes a first information obtainer 121 that obtains information indicating the amount of charge of the EVs 20 which are connected to the power system 140 and which are capable of receiving transmission power via the system facility 11. The control apparatus 120 also includes a second information obtainer 122 that obtains information indicating a first threshold set for the amount of charge of the EVs 20. The first threshold will be described later.

The controller 125 is a circuit, for example, and performs a role of performing information processing such as input processing, output processing, and arithmetic processing of information. The controller 125 may be a processor such as a central processing unit (CPU) or a microprocessor unit (MPU) or may include a plurality of circuit elements. Operation of the control apparatus 120 is basically achieved by the controller 125. The controller 125 also obtains information for controlling charging or discharging at each charging site 130. The controller 125 may receive input information via an input interface or receive information via a communication interface. The controller 125 also outputs charging control information at each charging site 130 to the charging site 130.

The storage 126 is a memory, for example, and performs a role of storing information. The storage 126 may be a circuit. The storage 126 may be a volatile memory or a nonvolatile memory. The storage 126 may include a plurality of memory elements. The storage 126 stores the power capacity of the system facility 11, the first threshold relating to the amount of charge of the EVs 20, and various other types of information.

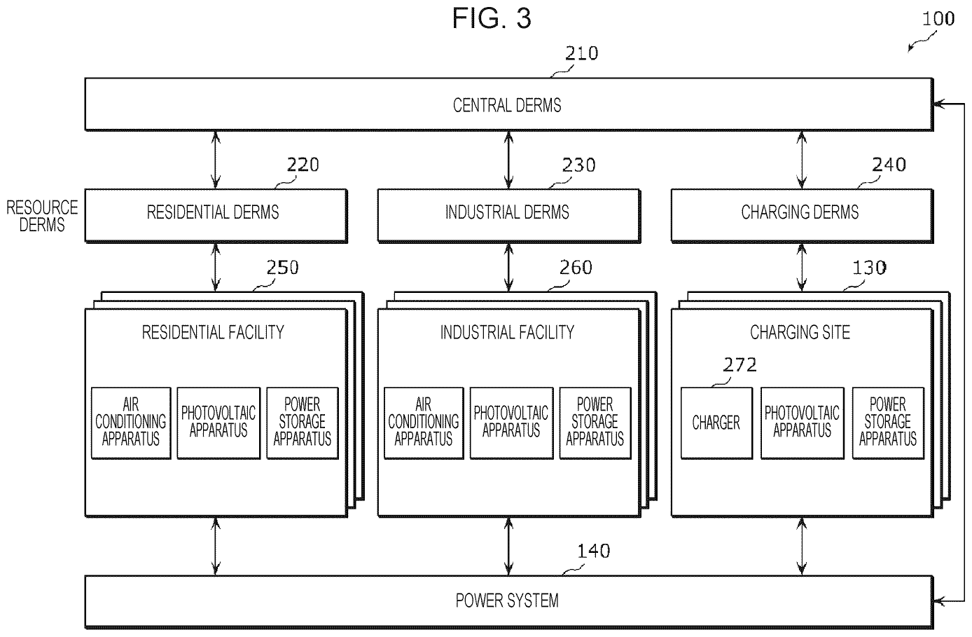

FIG. 3 is a block diagram illustrating a specific example of the power control system 100.

The power control system 100 illustrated in FIG. 3 includes a central distributed energy resource management system (DERMS) 210. The power control system 100 also includes a residential DERMS 220, an industrial DERMS 230, a charging DERMS 240, a plurality of residential facilities 250, a plurality of industrial facilities 260, the plurality of charging sites 130, and the power system 140.

The central DERMS 210 is a computer, for example, corresponds to the management apparatus 110 illustrated in FIG. 2, and performs the same role as the management apparatus 110. For example, the central DERMS 210 is a system of a power company and manages the transmission power flowing through the power system 140 and the system facilities 11 and 12 in the power system 140. The central DERMS 210 also adjusts the transmission power in coordination with the plurality of resource DERMS including the residential DERMS 220, the industrial DERMS 230, and the charging DERMS 240.

The residential DERMS 220 is a computer, for example, and manages power generation and power consumption at the plurality of residential facilities 250. The residential facilities 250 are facilities at human residential spaces and include air conditioning apparatuses, photovoltaic apparatuses, and power storage apparatuses. The residential DERMS 220 obtains information indicating a state of the power system 140 from the central DERMS 210 and transmits commands for controlling operation of the residential facilities 250 to the residential facilities 250 in accordance with the state of the power system 140.

The state of the power system 140 refers to a state of power supplied in the power system 140. The state of power supplied in the power system 140 includes, for example, states of currents, voltages, and power in the power system 140. The state of the power system 140 may be a state of power supply and demand in the power system 140.

The industrial DERMS 230 is a computer, for example, and manages power generation and power consumption at the plurality of industrial facilities 260. The industrial facilities 260 are facilities at factories, institutions, and the like and include air conditioning apparatuses, photovoltaic apparatuses, and power storage apparatuses. The industrial DERMS 230 obtains information indicating the state of the power system 140 from the central DERMS 210 and transmits commands for controlling operation of the industrial facilities 260 to the industrial facilities 260 in accordance with the state of the power system 140.

The charging DERMS 240 is an example of the control apparatus 120 illustrated in FIG. 2. The charging DERMS 240 is a computer, for example, and manages power generation and power consumption at the plurality of charging sites 130. The charging sites 130 are charging facilities and include the chargers 272, photovoltaic apparatuses, and power storage apparatuses. The chargers 272, the photovoltaic apparatuses, and the power storage apparatuses are examples of power loads 30. The charging DERMS 240 obtains information indicating the state of the power system 140 from the central DERMS 210 and transmits commands for controlling operation of the charging sites 130 in accordance with the state of the power system 140.

Each resource DERMS receives information regarding the power capacities of the system facilities 11 and 12 and the like from the central DERMS 210.

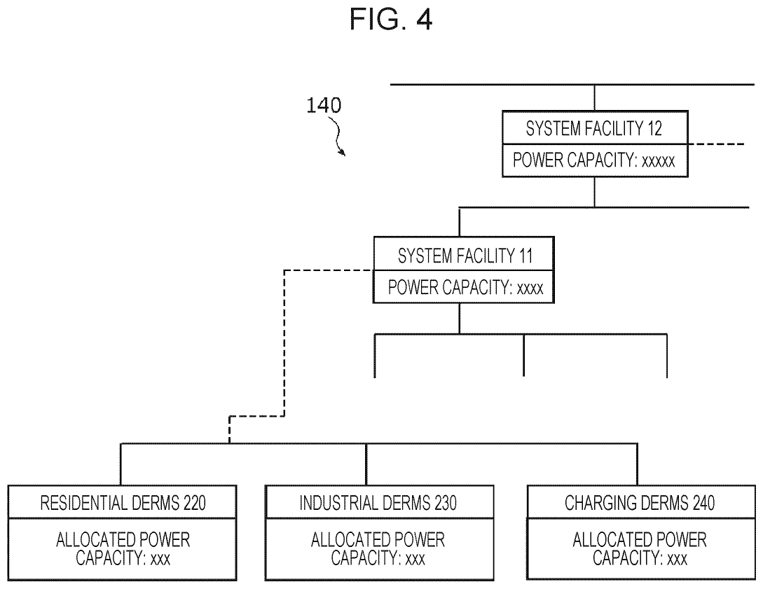

FIG. 4 is a diagram illustrating the information regarding the power capacity of the system facility 11 and the like.

FIG. 4 illustrates the power capacity of the system facility 11 and power capacities allocated to the residential DERMS 220, the industrial DERMS 230, and the charging DERMS 240.

The residential DERMS 220 manages the power generation and the power consumption of the residential facilities 250 such that an upper limit of the power capacity allocated to the residential DERMS 220 is not exceeded. The industrial DERMS 230 manages the power generation and the power consumption of the industrial facilities 260 such that an upper limit of the power capacity allocated to the industrial DERMS 230 is not exceeded. The charging DERMS 240 manages charging or discharging of the EVs 20 at the charging sites 130 such that an upper limit of the power capacity allocated to the charging DERMS 240 is not exceeded.

Since the power capacity of the system facility 11 is allocated to a plurality of resource DERMS, the power capacity allocated to the charging DERMS 240 is smaller than the power capacity of the system facility 11. That is, the charging DERMS 240 manages charging or discharging of the EVs 20 such that transmission power via the system facility 11 does not exceed an upper limit smaller than or equal to the power capacity of the system facility 11. Each DERMS may manage power generation and power consumption such that the transmission power via the system facility 11 does not exceed the upper limit smaller than or equal to the power capacity of the system facility 11.

The power capacity allocated to the charging DERMS 240 may be configured to vary depending on the season, the day, and the time of the day. In the following description, the charging DERMS 240 will also be referred to as the DERMS 240.

The DERMS 240 determines whether the transmission power via the system facility 11 exceeds the upper limit smaller than or equal to the power capacity of the system facility 11. If transmission power (power managed by the DERMS 240) transmitted from the system facility 11 is smaller than or equal to the power capacity allocated in advance, the DERMS 240 charges the EVs 20 connected to the charging sites 130 as usual. If the transmission power transmitted from the system facility 11 exceeds the power capacity allocated in advance, on the other hand, the DERMS 240 controls charging or discharging of the EVs 20 connected to the charging sites 130.

The DERMS 240 identifies EVs 20 to be subjected to the charging control or the discharging control. The EVs 20 to be subjected to the charging control or the discharging control are EVs that affect the system facility 11 with respect to the transmission power.

For example, the DERMS 240 identifies EVs in a power-strained area where power is in short supply as the EVs 20 to be subjected to the charging control or the discharging control. Whether a certain area is a power-strained area can be determined on the basis of information indicating the state of the power system 140. For example, the power-strained area is an area at a level under a system facility that exceeds a power capacity allocated by the DERMS 240. Information regarding EVs 20 in a power-strained area can be obtained on the basis of distribution map information indicating positions of the charging sites 130 (or the chargers 272).

The DERMS 240 instructs the charging sites 130 (or the chargers 272 or the EVs 20) to send information regarding the amount of charge of the identified EVs 20 thereto.

The charging sites 130 transmit information regarding the amount of charge of the EVs 20 to the DERMS 240. The first information obtainer 121 included in the DERMS 240 obtains the information indicating the amount of charge of the EVs 20.

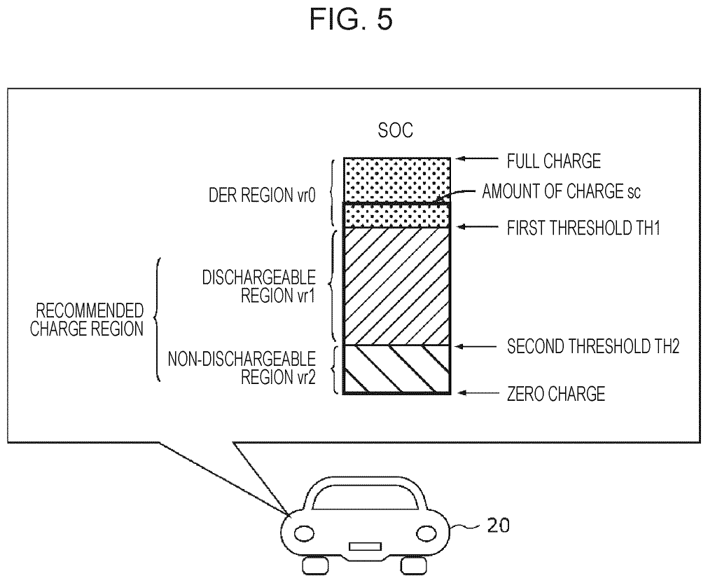

FIG. 5 is a diagram illustrating a states of charge (SOC) of an EV 20.

As illustrated in FIG. 5, the SOC of the EV 20 can be divided into a distributed energy resource (DER) region vr0 and a recommended charge region.

The DER region vr0 is a region indicating the amount of charge set in advance by a user of the EV 20. The DER region vr0 can be freely set by the user within a range specified for protecting the battery. The DERMS 240 can adjust power in the DER region vr0 set by the user.

The recommended charge region is a region indicating a recommended amount of charge. The recommended charge region is a region that cannot be set by the user of the EV 20. The recommended charge region can be divided into a dischargeable region vr1 in which power may be discharged and a non-dischargeable region vr2 in which power may not be discharged. The dischargeable region vr1 and the non-dischargeable region vr2 are determined in advance in accordance with battery characteristics and life.

The DERMS 240 obtains information regarding thresholds for the amount of charge set for the EV 20.

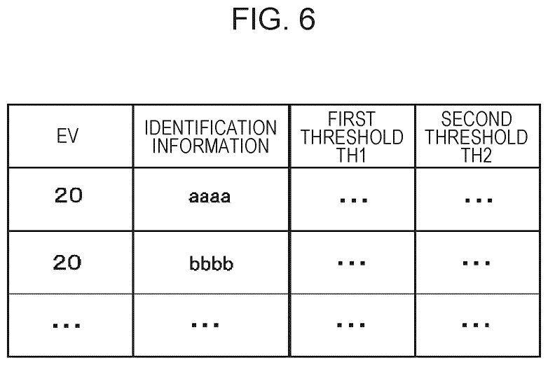

FIG. 6 is a diagram illustrating the information regarding the thresholds for the amount of charge set for the EVs 20 and the like. FIG. 6 illustrates identification numbers of the plurality of EVs 20, a first threshold TH1, and a second threshold TH2. The second information obtainer 122 described above obtains the information regarding the first threshold TH1 and the second threshold TH2.

The first threshold TH1 is a value set by the user of each EV 20. The first threshold TH1 is set as the amount of charge that is to remain accumulated in the EV 20 without being discharged. This means that the first threshold TH1 is a value indicating a boundary between the DER region vr0 and the dischargeable region vr1. The first threshold TH1 is smaller than the amount of charge with which completion of charging of the EV 20 is determined.

The second threshold TH2 is a value set in advance on the basis of a type of battery of each EV 20. The second threshold TH2 is determined in advance in accordance with battery characteristics and life. The second threshold TH2 is a value indicating a boundary between the dischargeable region vr1 and the non-dischargeable region vr2. The second threshold TH2 is larger than zero charge and smaller than the first threshold TH1.

When the transmission power via the system facility 11 exceeds an upper limit smaller than or equal to the power capacity of the system facility 11, the DERMS 240 performs the following control on the basis of a comparison between an amount of charge sc of each EV 20 and the first threshold TH1. The power capacity may be determined as being exceeded not only when the power capacity is actually exceeded but also when the power capacity is expected to be exceeded.

For example, when the amount of charge sc of the EV 20 is smaller than or equal to the first threshold TH1, the DERMS 240 continues to charge the EV 20. That is, when the amount of charge sc is in the recommended charge region, the DERMS 240 continues to charge the EV 20 until the first threshold TH1 set by the user is approached.

When the amount of charge sc of the EV 20 is larger than the first threshold TH1, on the other hand, the DERMS 240 controls the charging of the EV 20 in such a way as to reduce the transmission power via the system facility 11.

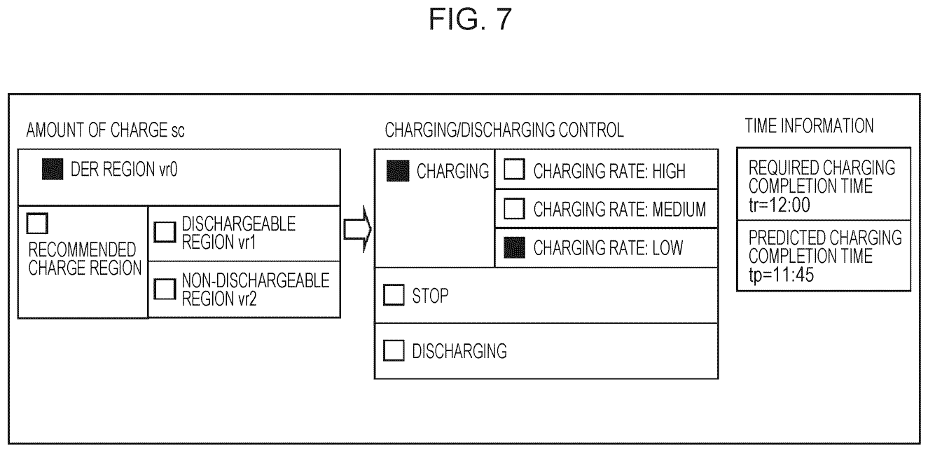

FIG. 7 is a diagram illustrating the amount of charge sc of the EV 20, information regarding the charging control or the discharging control, and the like. FIG. 7 illustrates an example of the amount of charge sc and the charging control or the discharging control.

FIG. 7 also illustrates a required charging completion time tr and a predicted charging completion time tp with respect to the first threshold TH1.

When the amount of charge sc of the EV 20 is in the DER region vr0, that is, when the amount of charge sc is larger than the first threshold TH1, the DERMS 240 reduces power for charging the EV 20. Specifically, the DERMS 240 reduces the power for charging the EV 20 by reducing a charging rate during the charging. As a result, the DERMS 240 adjusts power within a range of the DER region vr0 set by the user.

If the transmission power via the system facility 11 is still larger than the upper limit smaller than or equal to the power capacity even after the power for charging the EV 20 is reduced, the DERMS 240 may discharge power held by the EV 20 to the power system 140 or power loads 30 that are receiving power via the system facility 11. The EV 20 to be subjected to discharging is an EV whose amount of charge sc is larger than the first threshold TH1, that is, whose amount of charge sc is in the DER region vr0. The discharging may be performed after charging of all EVs 20 whose amount of charge sc is in the DER region vr0 is stopped.

If the transmission power via the system facility 11 is still larger than the upper limit smaller than or equal to the power capacity even after the power (accumulated power) accumulated in the EV 20 is discharged, the DERMS 240 may reduce power for charging EVs 20 whose amount of charge sc is in the dischargeable region vr1. If the transmission power via the system facility 11 is still larger than the upper limit smaller than or equal to the power capacity even after the power for charging the EVs 20 whose amount of charge sc is in the dischargeable region vr1 is reduced, the DERMS 240 may discharge the EVs 20 until the amount of charge corresponding to the dischargeable region vr1 reaches the second threshold TH2.

As described above, when the transmission power via the system facility 11 exceeds the upper limit smaller than or equal to the power capacity of the system facility 11, the DERMS 240 controls charging of each EV 20 on the basis of a comparison between the amount of charge sc of the EV 20 and the first threshold TH1 in such a way as to reduce the transmission power via the system facility 11. As a result, the power system 140 can be stably operated, and an adequate amount of charge can be secured for the EV 20.

### Control Method

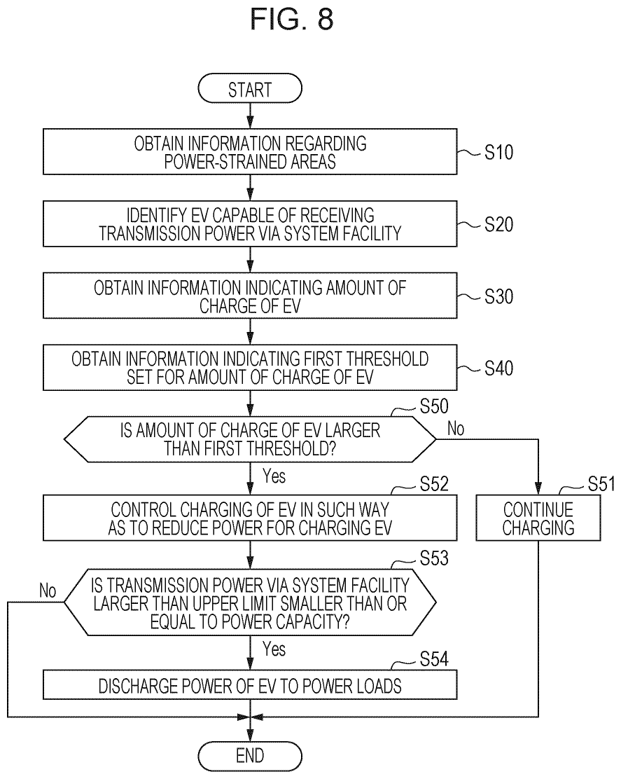

A control method according to the embodiment will be described with reference to FIG. 8. The management apparatus 110 described hereinafter corresponds to the central DERMS 210, and the control apparatus 120 corresponds to the charging DERMS 240.

FIG. 8 is a flowchart illustrating the control method according to the embodiment.

First, the control apparatus 120 obtains information regarding power-strained areas where power is in short supply (step S10). For example, the control apparatus 120 obtains, from the management apparatus 110, information regarding power-strained areas where power is in short supply and non-power-strained areas where power is not in short supply.

The control apparatus 120 outputs a control command to EVs 20 in the non-power-strained areas to cause the EVs 20 to be subjected to charging up to the DER region vr0 as usual.

For the power-strained areas, on the other hand, the control apparatus 120 performs the following control.

First, the control apparatus 120 identifies an EV 20 in the power-strained areas (step S20). The power-strained areas are defined as system areas where the transmission power via the system facility 11 exceeds an upper limit smaller than or equal to the power capacity of the system facility 11 and the transmission power via the system facility 11 can be received.

The control apparatus 120 obtains information indicating the amount of charge sc of the EV 20 identified in step S20 (step S30).

The control apparatus 120 also obtains information indicating the first threshold TH1 set for the amount of charge sc of the EV 20 (step S40). The first threshold TH1 is a value set by the user of the EV 20 as the amount of charge to be secured for the EV 20 without being discharged. The first threshold TH1 is a value smaller than the amount of charge with which completion of charging of the EV 20 is determined. Step S40 may be performed between steps S20 and S30, instead.

The control apparatus 120 controls charging or discharging of the EV 20 on the basis of a comparison between the amount of charge sc of the EV 20 and the first threshold TH1. Specifically, the control apparatus 120 determines whether the amount of charge sc of the EV 20 is larger than the first threshold TH1 (step S50).

For example, if the amount of charge sc of the EV 20 is smaller than the first threshold TH1 (NO in S50), the control apparatus 120 continues the charging (step S51).

If the amount of charge sc of the EV 20 is larger than the first threshold TH1 (YES in S50), on the other hand, the control apparatus 120 controls the charging of the EV 20 in such a way as to reduce power for charging the EV 20 (step S52). That is, the control apparatus 120 controls the charging of the EV 20 in such a way as to reduce transmission power for the EV 20.

The control apparatus 120 then determines, after reducing the power for charging the EV 20, whether the transmission power via the system facility 11 is larger than the upper limit smaller than or equal to the power capacity (step S53).

If the transmission power is smaller than the upper limit smaller than or equal to the power capacity (NO in S53), the control apparatus 120 determines that the power shortage has been resolved, and ends the charging control or the discharging control based on this flowchart. If the transmission power is larger than the upper limit smaller than or equal to the power capacity (YES in S53), on the other hand, the control apparatus 120 discharges the power of the EV 20 to the power system 140 or the power loads 30 that are receiving power via the system facility 11 (step S54).

As a result of steps S10 to S54, the control method according to the embodiment is performed. Consequently, the power system 140 can be stably operated, and an adequate amount of charge can be secured for the EV 20.

### First Modification of Embodiment

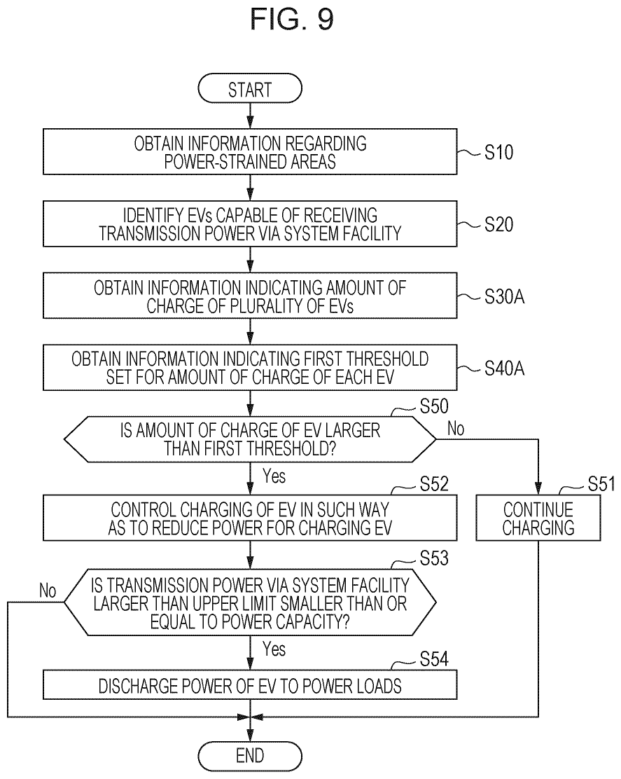

A control method according to a first modification of the embodiment will be described with reference to FIG. 9. In the first modification, an example in which charging control or discharging control is performed on a plurality of EVs 20 will be described.

FIG. 9 is a flowchart illustrating the control method according to the first modification of the embodiment.

First, the control apparatus 120 obtains information regarding power-strained areas where power is in short supply (step S10).

Next, the control apparatus 120 identifies EVs 20 in the power-strained areas (step S20). In the first modification, a plurality of EV 20 is identified. The power-strained areas are defined as system areas where the transmission power via the system facility 11 exceeds an upper limit smaller than or equal to the power capacity of the system facility 11 and the transmission power via the system facility 11 can be received.

The control apparatus 120 obtains information indicating the amount of charge sc of the plurality of EVs 20 identified in step S20 (step S30A).

The control apparatus 120 also obtains information regarding the first threshold TH1 set for the amount of charge of each EV 20 (step S40A).

The control apparatus 120 controls charging or discharging of each EV 20 on the basis of a comparison between the amount of charge sc of the EV 20 and the first threshold TH1. Specifically, the control apparatus 120 determines whether the amount of charge sc of each EV 20 is larger than the first threshold TH1 (step S50).

For example, if the amount of charge sc of the EV 20 is smaller than the first threshold TH1 (NO in S50), the control apparatus 120 continues the charging (step S51).

If the amount of charge sc of the EV 20 is larger than the first threshold TH1 (YES in S50), on the other hand, the control apparatus 120 controls the charging of the EV 20 in such a way as to reduce power for charging the EV 20 (step S52). That is, the control apparatus 120 controls the charging of the EV 20 in such a way as to reduce the power for charging the EV 20. The amount of reduction is determined in accordance with total reducible power (charged power in the DER region vr0) of the EVs in the power-strained areas and the amount of power to be reduced to resolve the power shortage. If the former is larger than the latter, for example, power obtained by dividing the amount of power to be reduced to resolve the power shortage by the number of EVs 20 to be subjected to the reduction may be assigned to each EV, or the assignment may be adjusted in order of priority. If not, the charging of the target EVs may be stopped.

If the transmission power via the system facility 11 is still larger than the upper limit smaller than or equal to the power capacity even after the power for charging a predetermined one of the plurality of EVs 20 is reduced, the control apparatus 120 discharges power of the predetermined EV 20 or another EV 20 whose amount of charge sc is larger than the first threshold TH1 to the power system 140 or the power loads 30 that are receiving power from the system facility 11.

Specifically, the control apparatus 120 determines, after reducing the power for charging each of the plurality of EVs 20, determines whether the transmission power via the system facility 11 is larger than the upper limit smaller than or equal to the power capacity (step S53).

If the transmission power is smaller than the upper limit smaller than or equal to the power capacity (NO in S53), the control apparatus 120 determines that the power shortage has been resolved, and ends the charging control or the discharging control based on this flowchart. If the transmission power is larger than the upper limit smaller than or equal to the power capacity (YES in S53), on the other hand, the control apparatus 120 discharges power of each of the plurality of EVs 20 to the power system 140 or the power loads 30 that are receiving power via the system facility 11 (step S54). The amount of power to be discharged is determined in accordance with total dischargeable power (discharge power in the DER region vr0) of the EVs 20 in the power-strained areas and the amount of power to be reduced to resolve the power shortage. If the former is larger than the latter, for example, power obtained by dividing the amount of power to be reduced to resolve the power shortage by the number of EVs to be subjected to the discharging may be assigned to each EV, or the assignment may be adjusted in order of priority. If not, the target EVs may be subjected to maximum discharging.

As a result of steps S10 to S54, the control method according to the first modification of the embodiment is performed. As a result, the power system 140 can be stably operated, and an adequate amount of charge can be secured for the EVs 20.

When the transmission power via the system facility 11 and the system facility 12 exceeds an upper limit smaller than or equal to the power capacity of each system facility, the control apparatus 120 may control charging or discharging in such a way as to reduce the transmission power via the system facility 11 preferentially for EVs 20 capable of receiving transmission power from both the system facility 11 and the system facility 12 among the plurality of EVs 20.

When the transmission power via the system facility 11 in the power system 140 exceeds the upper limit smaller than or equal to the power capacity of the system facility 11, the control apparatus 120 may control charging or discharging preferentially for EVs 20 with shorter power lines to the system facility 11 among the plurality of EVs 20. The power lines herein refer to distribution lines constituting the distribution network.

When the transmission power via the system facility 11 in the power system 140 exceeds the upper limit smaller than or equal to the power capacity of the system facility 11, the control apparatus 120 may control charging or discharging preferentially for EVs 20 that have obtained smaller incentives in a past period among the plurality of EVs 20.

The incentive may be, for example, a fixed incentive that defines an upper limit of the amount of power that can be discharged per month. In a case where power is discharged for a fee exceeding the upper limit of the amount of power that can be discharged, the control apparatus 120 may preferentially discharge EVs 20 with larger margins relative to the upper limit of the amount of power that can be discharged. When all the EVs 20 have reached the upper limit of the amount of power that can be discharged, the control apparatus 120 may preferentially discharge EVs 20 with smaller amounts of power discharged for a fee.

### Second Modification of Embodiment

A control method according to a second modification of the embodiment will be described. In the second modification, an example in which charging control or discharging control of EVs 20 is performed when the amount of charge sc of at least one of the EVs 20 is in the dischargeable region vr1 will be described.

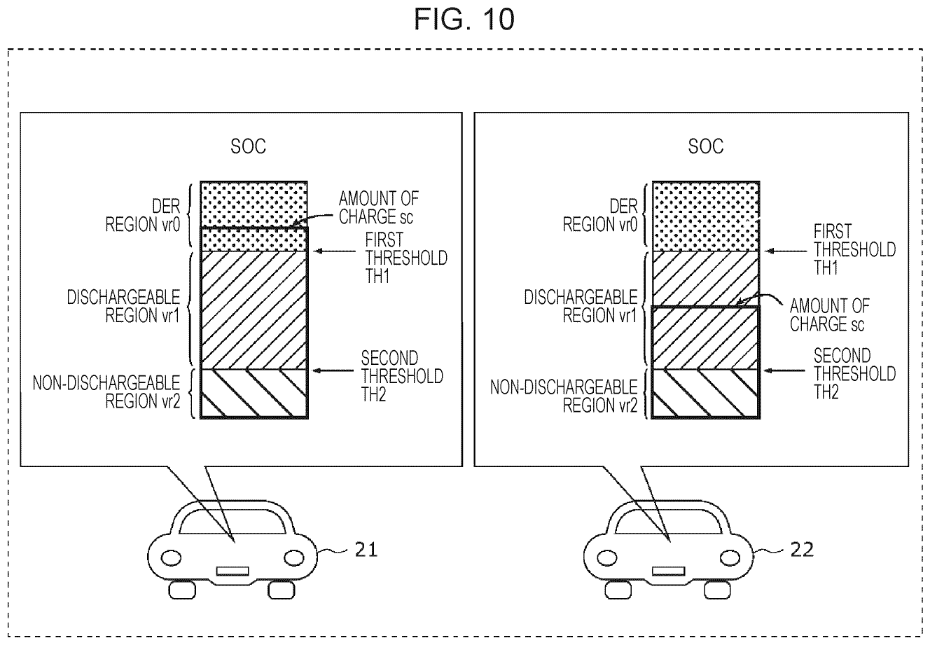

FIG. 10 is a diagram illustrating SOCs of the EVs 20 according to the second modification of the embodiment.

FIG. 10 illustrates an EV 21 whose amount of charge sc is in the DER region vr0 and an EV 22 whose amount of charge sc is in the dischargeable region vr1. The amount of charge sc of the EV 21 in the second modification is larger than the first threshold TH1.

The amount of charge sc of the EV 22 in the second modification is larger than the second threshold TH2 and smaller than or equal to the first threshold TH1.

The first threshold TH1 is the same as in the embodiment. The second threshold TH2 is set in advance on the basis of types of batteries of the EVs 20. The second threshold TH2 may be determined in advance in accordance with battery characteristics and life, or may be determined by users as with the first threshold TH1. The second threshold TH2 is smaller than the first threshold TH1 and is a value indicating the boundary between the dischargeable region vr1 and the non-dischargeable region vr2.

In the following description, a term “EV(s) 20” might be used to refer to one or both of the EVs 21 and 22.

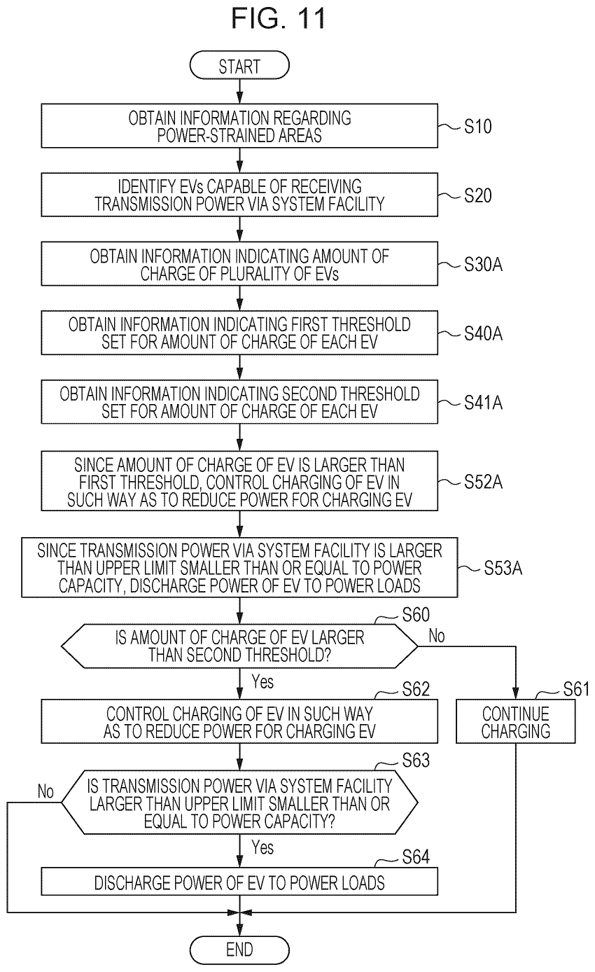

FIG. 11 is a flowchart illustrating the control method according to the second modification of the embodiment.

First, the control apparatus 120 obtains information regarding power-strained areas where power is in short supply (step S10).

Next, the control apparatus 120 identifies EVs 20 in the power-strained areas (step S20). In the second modification, the plurality of EVs 21 and 22 is identified. The power-strained areas are defined as system areas where the transmission power via the system facility 11 exceeds an upper limit smaller than or equal to the power capacity of the system facility 11 and the transmission power via the system facility 11 can be received.

The control apparatus 120 obtains information indicating the amount of charge sc of the plurality of EVs 21 and 22 identified in step S20 (step S30A).

The control apparatus 120 also obtains information indicating the first threshold TH1 set for the amount of charge sc of each EV 20 (step S40A). The control apparatus 120 further obtains information indicating the second threshold TH2 set for the amount of charge sc of the EV 22 (step S41A). Step S41A may be performed between steps S20 and S40A, instead.

The control apparatus 120 controls charging or discharging of the EVs 21 and 22 on the basis of comparisons between the amount of charge sc of the EVs 21 and 22 and the first threshold TH1. Since the amount of charge sc of the EV 21 is larger than the first threshold TH1 in this example, the control apparatus 120 controls charging of the EV 21 in such a way as to reduce power for charging the EV 21 (step S52A). That is, the control apparatus 120 controls the charging of the EV 21 in such a way as to reduce transmission power for the EV 21.

It is assumed in this example that the transmission power via the system facility 11 is larger than the upper limit smaller than or equal to the power capacity even after step S52A. The control apparatus 120, therefore, discharges power of the EV 21 whose amount of charge sc is larger than the first threshold TH1 to the power system 140 or the power loads 30 that are receiving power via the system facility 11 (step S53A). It is assumed in this example that the transmission power via the system facility 11 is larger than or equal to the upper limit smaller than or equal to the power capacity even after step S53A.

Next, the control apparatus 120 controls charging or discharging of the EV 22 on the basis of a comparison between the amount of charge sc of the EV 22 and the second threshold TH2. Specifically, the control apparatus 120 determines whether the amount of charge sc of the EV 22 is larger than the second threshold TH2 (step S60).

If the amount of charge sc of the EV 22 is smaller than the second threshold TH2 (NO in S60), for example, the control apparatus 120 continues the charging (step S61).

If the amount of charge sc of the EV 22 is larger than the second threshold TH2 (YES in S60), on the other hand, the control apparatus 120 controls the charging of the EV 22 in such a way as to reduce power for charging the EV 22 (step S62). That is, the control apparatus 120 controls the charging of the EV 22 in such a way as to reduce transmission power for the EV 22.

As described above, if the transmission power via the system facility 11 exceeds the upper limit smaller than or equal to the power capacity even after the power for the EV 21 is reduced or the EV 21 is discharged, the control apparatus 120 may reduce the power for charging the EV 22 even if the amount of charge sc of the EV 22 is smaller than the first threshold TH1. Because maintaining system stability is the highest priority, the amount of reduction in power for charging is an amount necessary to prevent transmission power via a system facility from exceeding an upper limit smaller than or equal to a power capacity. When there is a plurality of EVs 22 and it is possible to prevent transmission power via a system facility from exceeding an upper limit smaller than or equal to a power capacity of the system facility with an amount of reduction in power for charging with which charging can be completed by the required charging completion time tr (refer to FIG. 7), for example, the power for charging EVs 22 for which charging is expected to be completed by the required charging completion time tr is preferentially reduced, and the amount of reduction is an amount with which the charging is expected to be completed by the required charging completion time tr.

The control apparatus 120 controls the power for charging on the basis of the required charging completion time tr and the current amount of charge sc of the EV 22.

The control apparatus 120 then determines, after reducing the power for charging the plurality of EVs 21 and 22, whether the transmission power via the system facility 11 is larger than the upper limit smaller than or equal to the power capacity (step S63).

If the transmission power is smaller than the upper limit smaller than or equal to the power capacity (NO in S63), the control apparatus 120 determines that the power shortage has been resolved, and ends the charging control or the discharging control based on this flowchart. If the transmission power is larger than the upper limit smaller than or equal to the power capacity (YES in S63), on the other hand, the control apparatus 120 discharges power of the EV 22 to the power system 140 or the power loads 30 that are receiving power from the system facility 11 (step S64).

As a result of steps S10 to S64, the control method according to the second modification of the embodiment is performed. As a result, the power system 140 can be stably operated, and an adequate amount of charge can be secured for the EVs 20.

### Third Modification of Embodiment

A control method according to a third modification of the embodiment will be described. In the third modification, an example in which charging control or discharging control of a plurality of EVs 22 is performed when the amount of charge sc of the plurality of EVs 22 is in the dischargeable region vr1 will be described. The third modification is an example of a case where there is no EV 21 whose amount of charge sc is larger than the first threshold TH1.

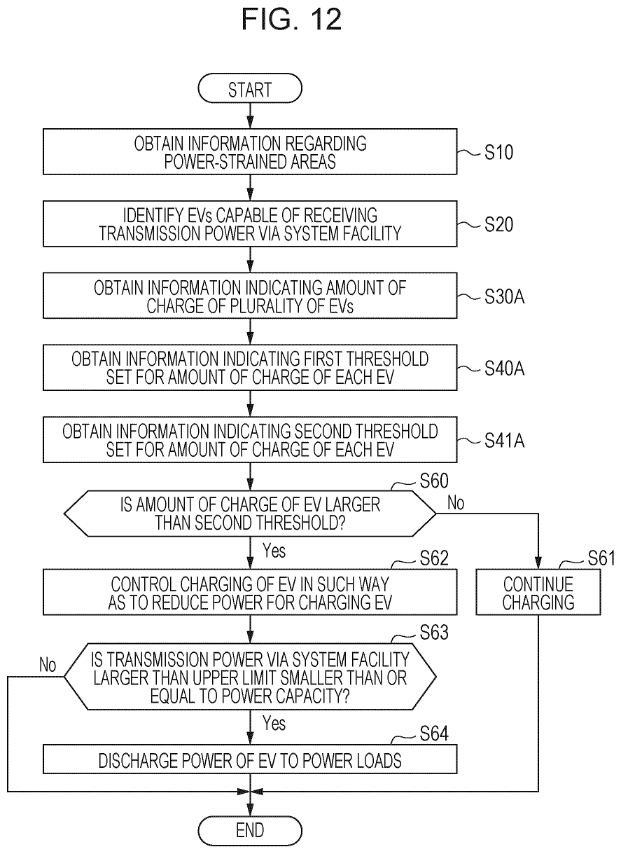

FIG. 12 is a flowchart illustrating the control method according to the third modification of the embodiment.

First, the control apparatus 120 obtains information regarding power-strained areas where power is in short supply (step S10).

Next, the control apparatus 120 identifies EVs 20 in the power-strained areas (step S20). In the third modification, the plurality of EVs 22 is identified. The power-strained areas are defined as system areas where the transmission power via the system facility 11 exceeds an upper limit smaller than or equal to the power capacity of the system facility 11 and the transmission power via the system facility 11 can be received.

The control apparatus 120 obtains information indicating the amount of charge sc of the plurality of EVs 22 identified in step S20 (step S30A).

The control apparatus 120 also obtains information indicating the first threshold TH1 set for the amount of charge sc of each of the EVs 22 (step S40A). The control apparatus 120 further obtains information indicating the second threshold TH2 set for the amount of charge sc of each of the EVs 22 (step S41A).

The control apparatus 120 controls charging or discharging of each EV 22 on the basis of a comparison between the amount of charge sc of the EV 22 and the second threshold TH2. Specifically, the control apparatus 120 determines whether the amount of charge sc of the EV 22 is larger than the second threshold TH2 (step S60).

If the amount of charge sc of the EV 22 is smaller than the second threshold TH2 (NO in S60), the control apparatus 120 continues the charging (step S61).

If the amount of charge sc of the EV 22 is larger than the second threshold TH2 (YES in S60), on the other hand, the control apparatus 120 controls charging of the EV 22 in such a way as to reduce power for charging the EV 22 (step S62). That is, the control apparatus 120 controls the charging of the EV 22 in such a way as to reduce transmission power for the EV 22. Because maintaining system stability is the highest priority, the amount of reduction in power for charging is an amount necessary to prevent transmission power via a system facility from exceeding an upper limit smaller than or equal to a power capacity. When there is a plurality of EVs 22 and it is possible to prevent transmission power via a system facility from exceeding an upper limit smaller than or equal to a power capacity of the system facility with an amount of reduction in power for charging with which charging can be completed by the required charging completion time tr (refer to FIG. 7), for example, the power for charging EVs 22 for which charging is expected to be completed by the required charging completion time tr is preferentially reduced, and the amount of reduction is an amount with which the charging is expected to be completed by the required charging completion time tr. The control apparatus 120 controls the power for charging on the basis of the required charging completion time tr of the EV 22 and the current amount of charge sc.

The control apparatus 120 may preferentially reduce power for charging EVs 22 whose predicted charging completion times tp up to the first threshold TH1 have greater margins with respect to the required charging completion times tr up to the first threshold TH1 desired by the users of the EVs 22 among the plurality of EVs 22.

The control apparatus 120 determines, after reducing the power for charging each of the plurality of EVs 22, whether the transmission power via the system facility 11 is larger than the upper limit smaller than or equal to the power capacity (step S63).

If the transmission power is smaller than the upper limit smaller than or equal to the power capacity (NO in S63), the control apparatus 120 determines that the power shortage has been resolved, and ends the charging control or the discharging control based on this flowchart. If the transmission power is larger than the upper limit smaller than or equal to the power capacity (YES in S63), on the other hand, the control apparatus 120 discharges power of each of the plurality of EVs 22 to the power system 140 or power loads 30 that are receiving power via the system facility 11 (step S64).

The amount of charge sc of the EVs 22 to be subjected to discharging needs to be larger than the second threshold TH2. Because maintaining system stability is the highest priority, the amount of power discharged is an amount necessary to prevent transmission power via a system facility from exceeding an upper limit smaller than or equal to a power capacity. When there is a plurality of EVs 22 and it is possible to prevent transmission power via a system facility from exceeding an upper limit smaller than or equal to a power capacity of the system facility with an amount of power discharged with which charging is expected to be completed by the required charging completion times tr, EVs 22 for which charging is expected to be completed by the required charging completion times tr are preferentially discharged, and the amount of power discharged is an amount with which the charging is expected to be completed by the required charging completion times tr.

As a result of steps S10 to S64, the control method according to the third modification of the embodiment is performed. As a result, the power system 140 is stably operated, and an adequate amount of charge can be secured for the EVs 20.

### Fourth Modification of Embodiment

A control method according to a fourth modification of the embodiment will be described.

The central DERMS 210 obtains information regarding an excess area where transmission power is likely to exceed a power capacity of a system facility and information regarding the amount of excess power, which is an excess over the power capacity. The central DERMS 210 provides the information regarding the excess area and the information regarding the amount of excess power to the DERMS 240.

The DERMS 240 controls charging or discharging of the EVs 20 as described hereinafter on the basis of the provided information regarding the excess area and the amount of excess power.

First, the DERMS 240 identifies charging sites 130 associated with a system facility 11 in the excess area. The DERMS 240 then charges EVs 20 connected to charging sites 130 outside the excess area up to the DER region vr0 as usual.

If the amount of charge sc of each EV 20 in the excess area is larger than the first threshold TH1, on the other hand, the DERMS 240 controls charging or discharging of the EV 20 in such a way as to reduce the transmission power via the system facility 11. Specifically, the DERMS 240 reduces power for charging the EV 20 by reducing a charging rate during the charging.

If the excess power still remains even after the power for charging each EV 20 is reduced, the DERMS 240 may discharge power of the EV 20 to the power system 140 or power loads 30 that are receiving power via the system facility 11. If the excess power still remains even after the power (accumulated power) accumulated in each EV 20 is discharged, the DERMS 240 may reduce power for charging each EV 20 whose amount of charge sc is in the dischargeable region vr1. If the excess power still remains even thereafter, discharging may be performed until the amount of charge sc in the dischargeable region vr1 reaches the second threshold TH2.

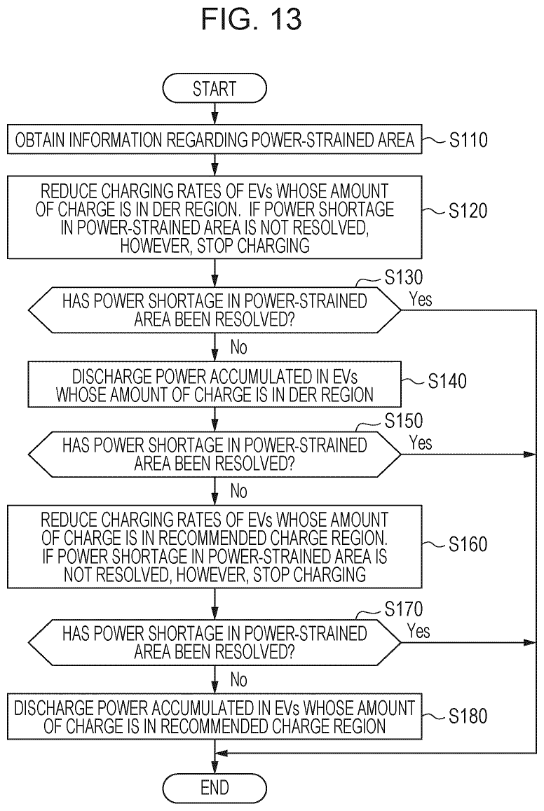

FIG. 13 is a flowchart illustrating the control method according to the fourth modification of the embodiment.

The management apparatus 110 described hereinafter corresponds to the central DERMS 210, and the control apparatus 120 corresponds to the DERMS 240. In the fourth modification, operations of the control apparatus 120 on a power-strained area will be described.

First, the control apparatus 120 obtains information regarding a power-strained area (step S110). The information regarding the power-strained area is transmitted, for example, from the management apparatus 110.

Next, the control apparatus 120 reduces charging rates of EVs 20 whose amount of charge sc is in the DER region vr0 among a plurality of EVs 20 in the power-strained area. If the power shortage in the power-strained area is not resolved, however, the control apparatus 120 stops the charging (step S120).

The control apparatus 120 determines whether the power shortage in the power-strained area has been resolved (step S130). If the power shortage has been resolved (YES in S130), the control apparatus 120 ends the charging control or the discharging control based on this flowchart.

If the power shortage has not been not resolved (NO in S130), the control apparatus 120 discharges power accumulated in EVs 20 whose amount of charge sc is in the DER region vr0 (step S140). When there is a plurality of EVs 20, the control apparatus 120 may discharge the EVs 20 while equally dividing the amount of power that needs to be discharged by the number of EVs 20.

The control apparatus 120 again determines whether the power shortage in the power-strained area has been resolved (step S150). If the power shortage has been resolved (YES in S150), the control apparatus 120 ends the charging control or the discharging control based on this flowchart.

If the power shortage has not been resolved (NO in S150), the control apparatus 120 reduces charging rates of EVs 20 whose amount of charge sc is in the recommended charge region among the plurality of EVs 20. If the power shortage in the power-strained area is not resolved, however, the control apparatus 120 stops the charging (step S160).

The control apparatus 120 again determines whether the power shortage in the power-strained area has been resolved (step S170). If the power shortage has been resolved (YES in S170), the control apparatus 120 ends the charging control or the discharging control based on this flowchart.

If the power shortage has not been resolved (NO in S170), the control apparatus 120 discharges power accumulated in EVs 20 whose amount of charge sc is in the recommended charge region (step S180).

The stop of charging, the change to the charging rate, and the discharging are performed for all target EVs 20 or EVs 20 selected on the basis of predetermined order of priority.

As a result of steps S110 to S180, the control method according to the fourth modification of the embodiment is performed. Consequently, the power system 140 can be stably operated, and an adequate amount of charge can be secured for the EVs 20.

### Fifth Modification of Embodiment

A control method according to a fifth modification of the embodiment will be described. In the fifth modification, an example in which charging control or discharging control is performed preferentially for EVs with larger margins relative to the required charging completion times tr among EVs 20 in the recommended charge region will be described.

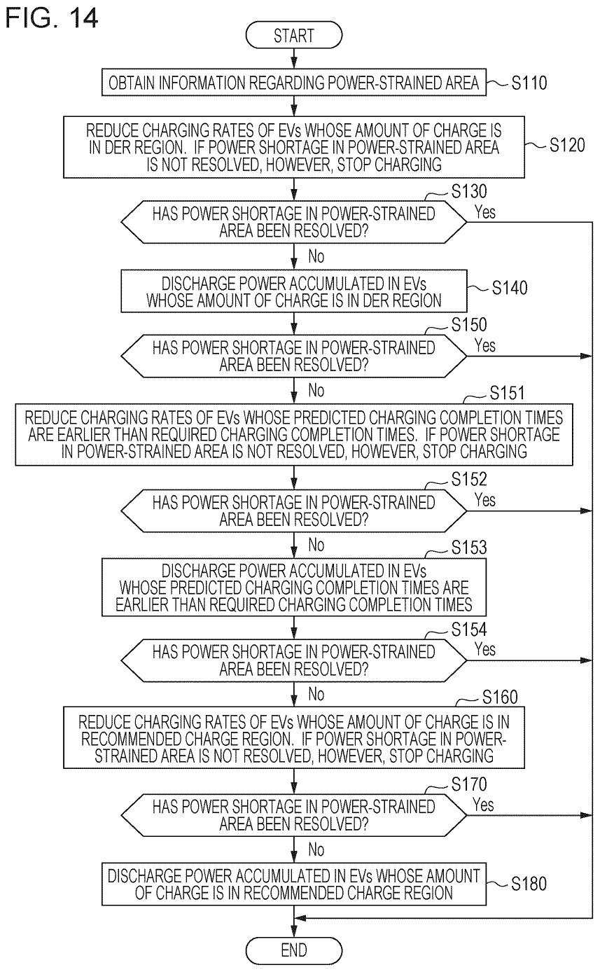

FIG. 14 is a flowchart illustrating the control method according to the fifth modification of the embodiment.

In the fifth modification, operations of the control apparatus 120 on a power-strained area will be described.

First, the control apparatus 120 obtains information regarding a power-strained area (step S110).

Next, the control apparatus 120 reduces charging rates of EVs 20 whose amount of charge sc is in the DER region vr0 among a plurality of EVs 20 in the power-strained area. If the power shortage in the power-strained area is not resolved, the control apparatus 120 stops the charging (step S120).

The control apparatus 120 determines whether the power shortage in the power-strained area has been resolved (step S130). If the power shortage has been resolved (YES in S130), the control apparatus 120 ends the charging control or the discharging control based on this flowchart.

If the power shortage has not been resolved (NO in S130), the control apparatus 120 discharges power accumulated in the EVs 20 whose amount of charge sc is in the DER region vr0 (step S140).

The control apparatus 120 again determines whether the power shortage in the power-strained area has been resolved (step S150). If the power shortage has been resolved (YES in S150), the control apparatus 120 ends the charging control or the discharging control based on this flowchart.

If the power shortage has not been resolved (NO in S150), the control apparatus 120 reduces charging rates of EVs 20 whose predicted charging completion times tp are earlier than the required charging completion times tr among EVs 20 whose amount of charge sc is in the recommended charge region. If the power shortage in the power-strained area is not resolved, however, the control apparatus 120 stops the charging (step S151).

The control apparatus 120 again determines whether the power shortage in the power-strained area has been resolved (step S152). If the power shortage has not been resolved (YES in S152), the control apparatus 120 ends the charging control or the discharging control based on this flowchart.

If the power shortage has not been resolved (NO in S152), the control apparatus 120 discharges power accumulated in EVs 20 whose predicted charging completion times tp are earlier than the required charging completion times tr among the EVs 20 whose amount of charge sc is in the recommended charge region (step S153).

The control apparatus 120 again determines whether the power shortage in the power-strained area has been resolved (step S154). If the power shortage has been resolved (YES in S154), the control apparatus 120 ends the charging control or the discharging control based on this flowchart.

If the power shortage has not been resolved (NO in S154), the control apparatus 120 reduces charging rates of other EVs whose amount of charge sc is in the recommended charge region among the plurality of EVs 20. If the power shortage in the power-strained area is not resolved, however, the control apparatus 120 stops the charging (step S160).

The control apparatus 120 again determines whether the power shortage in the power-strained area has been resolved (step S170). If the power shortage has been resolved (YES in S170), the control apparatus 120 ends the charging control or the discharging control based on this flowchart.

If the power shortage has not been resolved (NO in S170), the control apparatus 120 discharges power accumulated in the EVs 20 whose amount of charge sc is in the recommended charge region (step S180).

The stop of charging, the change to the charging rate, and the discharging are performed for all target EVs 20 or EVs 20 selected on the basis of predetermined order of priority.

As a result of steps S110 to S180, the control method according to the fifth modification of the embodiment is performed. Consequently, the power system 140 can be stably operated, and an adequate amount of charge can be secured for the EVs 20.

### OTHER EMBODIMENTS

Although aspects of a control apparatus have been described in accordance with an embodiment, aspects of the control apparatus are not limited to the embodiment. The embodiment may be modified in ways conceivable by those skilled in the art, and a plurality of components in the embodiment may be arbitrarily combined.

For example, a processing step performed by a specific component in the embodiment may be performed by another component, instead. Order of a plurality of processing steps may be changed, or a plurality of processing steps may be performed in parallel with each other. Ordinal numbers such as “first” and “second” used for the description may be exchanged, removed, or newly added as appropriate. These ordinal numbers do not necessarily correspond to meaningful order, and may be simply used for identifying of elements.

Any system or apparatus may perform a control method including steps performed by the components of the control apparatus, instead. That is, the control method may be performed by the above-described control apparatus or may be performed by a system or another apparatus.

For example, a part or the entirety of the control method may be performed by a computer including a processor, a memory, and an input/output circuit. At this time, a program for causing the computer to perform the control method may be executed by the computer to perform the control method.

The program may be stored in a non-transitory computer-readable storage medium such as a CD-ROM.

Each component of the control apparatus may be implemented as dedicated hardware, general-purpose hardware that executes the program or the like, or a combination of these. The general-purpose hardware may include a memory storing the program and a general-purpose processor that reads the program from the memory and that executes the program. Here, the memory may be a semiconductor memory, a hard disk, or the like, and the general-purpose processor may be a CPU or the like.

The dedicated hardware may include a memory and a dedicated processor. For example, the dedicated processor may refer to the memory and perform the control method.

Each component of the control apparatus may be an electrical circuit. These electrical circuits may together constitute a single electrical circuit, or may be discrete electrical circuits. These electrical circuits may correspond to the dedicated hardware or may correspond to the general-purpose hardware that executes the program or the like.

The present disclosure can be used as a control method and the like that achieve both stable operation of a power system and securing of an adequate amount of charge for EVs.

What is claimed is:

1. A control method comprising:
obtaining information indicating an amount of charge of at least one first electric vehicle that is connected to a power system and that is capable of receiving transmission power via a first system facility;
obtaining information indicating a first threshold set for the amount of charge of the at least one first electric vehicle; and
controlling, when the transmission power via the first system facility exceeds an upper limit smaller than or equal to a power capacity of the first system facility, charging or discharging of the at least one first electric vehicle on a basis of a comparison between the amount of charge of the at least one first electric vehicle and the first threshold in such a way as to reduce the transmission power via the first system facility.

2. The control method according to claim 1, further comprising:
identifying an electric vehicle capable of receiving the transmission power via the first system facility.

3. The control method according to claim 1,
wherein the first threshold is a value smaller than an amount of charge with which completion of charging of the at least one first electric vehicle is determined.

4. The control method according to claim 1,
wherein the first threshold is a value set by a user of the at least one first electric vehicle as an amount of charge of the at least one first electric vehicle to be secured without being discharged.

5. The control method according to claim 1,
wherein, when the transmission power via the first system facility is larger than the upper limit and the amount of charge of the at least one first electric vehicle is larger than the first threshold, power for charging the at least one first electric vehicle is reduced.

6. The control method according to claim 1,
wherein, when the amount of charge of the at least one first electric vehicle is larger than the first threshold, power of the at least one first electric vehicle is discharged to the power system or a power load that is receiving power via the first system facility.

7. The control method according to claim 5,
wherein, when the amount of charge of the at least one first electric vehicle is smaller than the first threshold, the charging is continued.

8. The control method according to claim 5,
wherein, if the transmission power via the first system facility is still larger than the upper limit even after the power for charging the at least one first electric vehicle is reduced, power of the at least one first electric vehicle is discharged to the power system or a power load that is receiving power via the first system facility.

9. The control method according to claim 5,
wherein the at least one first electric vehicle is a plurality of first electric vehicles, and
wherein, if the transmission power via the first system facility is still larger than the upper limit even after power for charging a predetermined one of the plurality of first electric vehicles is reduced, power of the predetermined first electric vehicle or another first electric vehicle whose amount of charge is larger than the first threshold is discharged to the power system or a power load that is receiving power via the first system facility.

10. The control method according to claim 6,
wherein the at least one first electric vehicle is a plurality of electric vehicles, and
wherein, among the plurality of first electric vehicles, the at least one first electric vehicle whose amount of charge is larger relative to the first threshold is preferentially discharged.

11. The control method according to claim 6, further comprising:
obtaining information indicating an amount of charge of at least one second electric vehicle that is connected to the power system and that is capable of receiving the transmission power via the first system facility; and
obtaining information indicating a first threshold set for the amount of charge of the at least one second electric vehicle,
wherein, if the transmission power via the first system facility exceeds the upper limit even after the power of the at least one first electric vehicle is discharged, power for charging the at least one second electric vehicle is reduced even if the amount of charge of the at least one second electric vehicle is smaller than the first threshold.

12. The control method according to claim 11,
wherein the amount of charge of the at least one second electric vehicle for which the power for charging is to be reduced is large enough to complete the charging up to the first threshold by a required charging completion time desired by a user of the at least one second electric vehicle even if the power for charging is reduced.

13. The control method according to claim 11,
wherein the at least one second electric vehicle is a plurality of second electric vehicles, and
wherein power for charging, among the plurality of second electric vehicles, a second electric vehicle whose predicted charging completion time up to the first threshold has a greater margin with respect to a required charging completion time up to the first threshold desired by a user of the second electric vehicle is preferentially reduced.

14. The control method according to claim 11, further comprising:
obtaining information indicating a second threshold that is set for the amount of charge of the at least one second electric vehicle and that is smaller than the first threshold,
wherein the amount of charge of the at least one second electric vehicle for which the power for charging is to be reduced is larger than the second threshold.

15. The control method according to claim 11,
wherein, if the transmission power via the first system facility still exceeds the upper limit even after the power for charging the at least one second electric vehicle is reduced, power of the at least one second electric vehicle is discharged to the power system or a power load that is receiving power via the first system facility.

16. The control method according to claim 11,
wherein the at least one second electric vehicle is a plurality of second electric vehicles, and
wherein, if the transmission power via the first system facility still exceeds the upper limit even after power for charging a predetermined one of the plurality of second electric vehicles is reduced, power of the predetermined second electric vehicle or another second electric vehicle is discharged to the power system or a power load that is receiving power via the first system facility.

17. The control method according to claim 16,
wherein, among the plurality of second electric vehicles, a second electric vehicle whose predicted charging completion time up to the first threshold has a greater margin with respect to a required charging completion time up to the first threshold desired by a user of the second electric vehicle is preferentially discharged.

18. The control method according to claim 15, further comprising:
obtaining information indicating the first threshold set for the amount of charge of the at least one second electric vehicle and information indicating a second threshold smaller than the first threshold,
wherein the amount of charge of the at least one second electric vehicle to be discharged is larger than the second threshold.

19. The control method according to claim 15,
wherein the amount of charge of the at least one second electric vehicle to be discharged is large enough to complete the charging up to the first threshold by a required charging completion time desired by a user of the at least one second electric vehicle even if the at least one second electric vehicle is discharged.

20. The control method according to claim 1,
wherein the at least one first electric vehicle is a plurality of first electric vehicles, and
wherein, when the transmission power via the first system facility and transmission power via a second system facility different from the first system facility exceed upper limits smaller than or equal to power capacities of the corresponding system facilities, charging or discharging is controlled preferentially for, among the plurality of first electric vehicles, a first electric vehicle capable of receiving the transmission power via both the first system facility and the second system facility.

21. The control method according to claim 1,
wherein the at least one first electric vehicle is a plurality of first electric vehicles, and
wherein, when the transmission power via the first system facility of the power system exceeds the upper limit smaller than or equal to the power capacity of the first system facility, charging or discharging is controlled preferentially for, among the plurality of first electric vehicles, a first electric vehicle whose power line to the first system facility is shorter.

22. The control method according to claim 1,
wherein the at least one first electric vehicle is a plurality of first electric vehicles, and
wherein, when the transmission power via the first system facility of the power system exceeds the upper limit smaller than or equal to the power capacity of the first system facility, charging or discharging is controlled preferentially for, among the plurality of first electric vehicles, a first electric vehicle that has obtained a smaller incentive in a past period.

23. A control method comprising:
obtaining information indicating an amount of charge of a plurality of first electric vehicles that are connected to a power system and that are capable of receiving transmission power via a first system facility; and
controlling, when the transmission power via the first system facility and transmission power via a second system facility different from the first system facility exceed upper limits smaller than or equal to power capacities of the corresponding system facilities, charging or discharging preferentially for, among the plurality of first electric vehicles, a first electric vehicle capable of receiving the transmission power via both the first system facility and the second system facility in such a way as to reduce the transmission power via the first system facility.

24. A control method comprising:
obtaining information indicating an amount of charge of a plurality of first electric vehicles that are connected to a power system and that are capable of receiving transmission power via a first system facility; and
controlling, when the transmission power via the first system facility of the power system exceeds an upper limit smaller than or equal to a power capacity of the first system facility, charging or discharging preferentially for, among the plurality of first electric vehicles, a first electric vehicle whose power line to the first system facility is shorter in such a way as to reduce the transmission power via the first system facility.

25. A control method comprising:
obtaining information indicating an amount of charge of a plurality of first electric vehicles that are connected to a power system and that are capable of receiving transmission power via the first system facility; and
controlling, when the transmission power via the first system facility of the power system exceeds an upper limit smaller than or equal to a power capacity of the first system facility, charging or discharging preferentially for, among the plurality of first electric vehicles, a first electric vehicle that has obtained a smaller incentive in a past period in such a way as to reduce the transmission power via the first system facility.

26. A control apparatus comprising:
a first information obtainer that obtains information indicating an amount of charge of at least one first electric vehicle that is connected to a power system and that is capable of receiving transmission power via a first system facility;
a second information obtainer that obtains information indicating a first threshold set for the amount of charge of the at least one first electric vehicle; and
a controller that controls, when the transmission power via the first system facility exceeds an upper limit smaller than or equal to a power capacity of the first system facility, charging or discharging of the at least one first electric vehicle on a basis of a comparison between the amount of charge of the at least one first electric vehicle and the first threshold in such a way as to reduce the transmission power via the first system facility.

27. A control apparatus comprising:
a first information obtainer that obtains information indicating an amount of charge of a plurality of first electric vehicles that are connected to a power system and that are capable of receiving transmission power via a first system facility; and
a controller that controls, when the transmission power via the first system facility and transmission power via a second system facility different from the first system facility exceed upper limits smaller than or equal to power capacities of the corresponding system facilities, charging or discharging preferentially for, among the plurality of first electric vehicles, a first electric vehicle capable of receiving the transmission power via both the first system facility and the second system facility in such a way as to reduce the transmission power via the first system facility.

28. A control apparatus comprising:
a first information obtainer that obtains information indicating an amount of charge of a plurality of first electric vehicles that are connected to a power system and that are capable of receiving transmission power via a first system facility; and
a controller that controls, when the transmission power via the first system facility of the power system exceeds an upper limit smaller than or equal to a power capacity of the first system facility, charging or discharging preferentially for, among the plurality of first electric vehicles, a first electric vehicle whose power line to the first system facility is shorter in such a way as to reduce the transmission power via the first system facility.

29. A control apparatus comprising:
a first information obtainer that obtains information indicating an amount of charge of a plurality of first electric vehicles that are connected to a power system and that are capable of receiving transmission power via the first system facility; and
a controller that controls, when the transmission power via the first system facility of the power system exceeds an upper limit smaller than or equal to a power capacity of the first system facility, charging or discharging preferentially for, among the plurality of first electric vehicles, a first electric vehicle that has obtained a smaller incentive in a past period in such a way as to reduce the transmission power via the first system facility.
